(19) United States
(12) Patent Application Publication
(10) Pub. No.: US 2005/0089155 A1
(43) Pub. Date: Apr. 28, 2005

(54) Technique for dynamically prioritizing communication calls to information/call centers

(76) Inventor: Neil E. Isenberg, Portland, OR (US)

Correspondence Address: ALEX L. YIP;KAYE SCHOLER LLP, 425 PARK AVENUE, NEW YORK, NY, 10022, US

(21) Appl. No.: 10/695,470

(22) Filed: Oct. 28, 2003

(51) Int. Cl. H04M 3/00; H04M 5/00

(52) U.S. Cl. 379/266.01; 379/266.06

(57) ABSTRACT

In providing an information assistance service, an information assistance call from a user is placed in a call queue when operators are not available to answer the call. In accordance with the invention, the call may be accorded priority in the call queue based on a measure of an excess wait time (EWT) incurred in a prior call(s) from the same user. The EWT is defined as the wait time for the service in excess of a predetermined acceptable service wait time, which may be greater than or equal to zero. The queue prioritization in accordance with the invention increases the likelihood of answering the current call from a user, who experienced a EWT in a prior call(s), within the acceptable service wait time.

### FIELD OF THE INVENTION

The invention relates to a communications system and method, and more particularly to an information assistance system and method for prioritizing communication calls.

### BACKGROUND OF THE INVENTION

It is common that an information assistance service provider sets up information/call centers (conveniently referred to hereinafter as “call centers”) in different geographic areas to handle information assistance calls from users. When all operators at a call center are busy answering information assistance calls, a subsequent call arriving at that call center is placed in a call queue to wait for the next available operator. Typically, overflowing information assistance calls are placed in the call queue based on their arrival times, e.g., in accordance with a first-in-first-out (FIFO) algorithm.

### SUMMARY OF THE INVENTION

The invention is premised upon a recognition that the call queuing algorithm used in a prior art information assistance service is memoryless. That is, in prior art, the wait period incurred in a previous information assistance call by a user is not taken into account in prioritizing the current call by the same user in a call queue. As a result, the user may be dissatisfied with the service if he/she consistently experiences a long wait period for the service, which is undesirable.

The invention overcomes the prior art limitations by taking into account the user's prior call experiences in prioritizing the current call. In accordance with the invention, after an information assistance system receives a current call from a user, and signals containing an identifier (e.g., an automatic number identification (ANI)) associated with the user, a processor determines whether the current call should be placed in a queue to wait for a service provider (e.g., an operator) to render an information assistance service. If the current call should be placed in a queue, a data source is searched for data associated with the user based on the identifier. Such data concerns at least one wait period before an information assistance service was rendered in at least one prior call to the system, which is identifiable by the same identifier. The current call is then placed in a queue based on the data.

In an illustrative embodiment, the wait period incurred in the user's last call, which may be offset by a predetermined, acceptable service wait time (e.g., greater than or equal to zero), is used to determine a position in the queue in which the user's current call is placed. The longer the wait period is, the more likely the current call placed ahead of other calls in the queue.

### BRIEF DESCRIPTION OF THE DRAWINGS

Further objects, features and advantages of the invention will become apparent from the following detailed description taken in conjunction with the accompanying drawings showing an illustrative embodiment of the invention, in which:

FIG. 1 is a block diagram of an information assistance system in accordance with the invention;

FIG. 2 illustrates a first example of an excess wait time (EWT) database in accordance with the invention;

FIGS. 3a and 3b illustrate first and second wait queues containing information assistance calls to be answered;

FIGS. 4a and 4b are flow charts depicting first and second call queuing processes in accordance with the invention;

FIG. 5 illustrates a second example of an EWT database in accordance with the invention;

FIGS. 6a and 6b illustrate third and fourth wait queues containing information assistance calls to be answered; and

FIG. 7 is a flow chart depicting a third call queuing process in accordance with the invention.

### DETAILED DESCRIPTION OF THE INVENTION

The invention is directed to promoting customer satisfaction of an information assistance service by controlling the service wait times of information assistance calls on a user by user basis. In an illustrative embodiment of the invention, priority is afforded to an information assistance call from a user who experienced in his/her last call an excess wait time (EWT), which is defined as the wait time in excess of a predetermined, acceptable service wait time, which may be greater than or equal to zero. In this instance, the acceptable service wait time is predetermined to be 20 seconds long. An EWT database is maintained which registers, for each user who made an information assistance call, the EWT of the user's call. For example, in the EWT database, a call incurring a service wait time of 30 seconds is said to have an EWT of 30−20=10 seconds. On the other hand, a call incurring a service wait time of 20 seconds or less is said to have a zero EWT. The user may be identified in the EWT database, e.g., by an identifier (e.g., telephone number) of the user's communications device (e.g., a telephone) from which the call originates.

When a subsequent information assistance call is received from the same user (or his/her telephone number) at a call center where all operators are busy answering other calls, the EWT database is checked to see what EWT value is associated with the user (or his/her telephone number). If the EWT value is larger than zero, the call is placed in the call queue ahead of other calls which, although arrived earlier, have smaller EWT values, in hopes that the call this time will be answered within the predetermined, acceptable service wait time to gain the user's service satisfaction.

In another illustrative embodiment, upon arrival of a current call from a user, the EWT database is searched not only for the EWT value of the last call when the user experienced an EWT, but also the date/time of such last call. If the date/time is more than a predetermined time period ago, e.g., a week ago, the non-zero EWT value may not be the controlling factor in placing the current call in the call queue, stemming from an assumption that the user is an infrequent user of the service and most likely would have forgotten the prior “bad” call experience. As such, no priority is accorded to the current call.

In yet another illustrative embodiment, the EWT database keeps track of all calls (or at least those calls incurring a non-zero EWT) on a cycle basis, e.g., a weekly cycle, a month cycle, etc. For each user, the EWT values of all of the calls from the user during the current cycle are cumulated. The cumulative EWT value (as opposed to only the EWT value of the last call in the previous embodiment) may be used to determine priority of the user's current call. This way, relatively frequent service users making, e.g., eight calls a month, who consistently experience small amounts of EWT, e.g., 5 seconds each, would be given priority over relatively infrequent users making, e.g., one call a month, who may have experienced a one-time large EWT, e.g., 35 seconds.

In still yet another embodiment, the cumulative EWT value associated with a user is averaged over the number of calls from the user in the current cycle which incur a non-zero EWT. The resulting, average EWT value may then be used to determine priority of the user's current call.

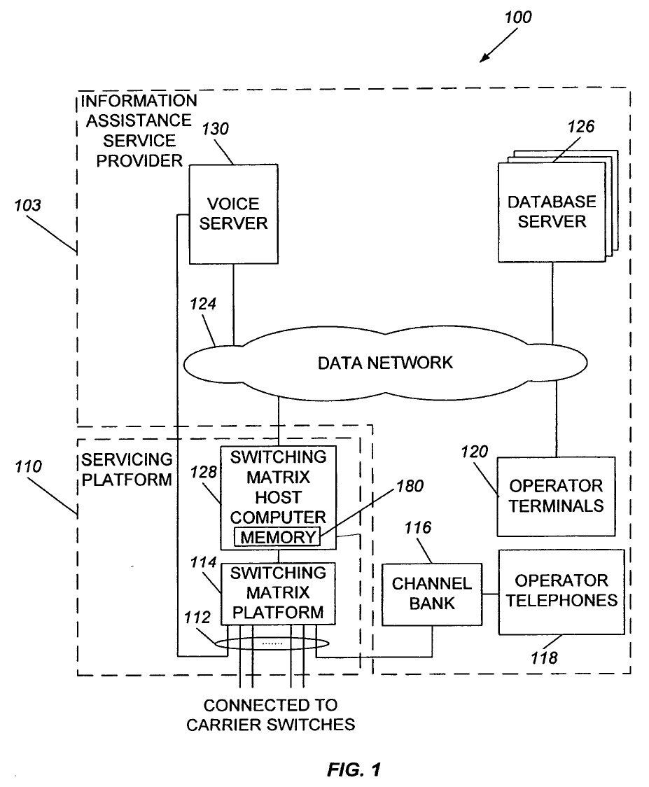

FIG. 1 illustrates information assistance system 100 embodying the principles of the invention. In this illustrative embodiment, callers of a particular telephone carrier may dial, speak or otherwise communicate predetermined access digits, access codes or retail numbers, or input a predetermined address or URL established by the carrier to access information assistance service provider 103. For example, the predetermined access digits may be “411,” “*555,” “555-1212,” “00,” etc. On learning one such access digit sequence initiated from a caller's communications device, a switching system of the caller's telephone carrier in a conventional manner routes the information assistance call to provider 103 through servicing platform 110.

It should be noted that even though both provider 103 and servicing platform 110 appear in the same figure, they may or may not be located in the same geographic area. In FIG. 1, servicing platform 110 comprises switching matrix platform 114 having T1 spans 112 for connection to voice server 130, channel bank 116, and carrier networks. Switching matrix platform 114 may receive an incoming information assistance call from one of the carrier networks through a carrier switch therein. It may also be used to place an outgoing call through one of the carrier networks which may be different than that used for the incoming call.

Channel bank 116 in provider 103 is used to couple multiple operator telephones 118 to switch 114. The operators in service 100 are further equipped with operator terminals 120, each of which includes a video display unit and a keyboard with associated dialing pad. Operator terminals 120 are connected over data network 124 to one or more database server(s) 126 (although only one is shown here). Switch host computer 128 and voice server 130 are also connected to data network 124. By way of example, data network 124 includes a local area network (LAN) supplemented by a number of point-to-point data links. Through data network 124 and routers (not shown), components of service 100, e.g., voice server 130, may also be connected to the Internet.

Switching matrix platform 114 is conventional and supports digital T1 connectivity. The operation of switching matrix platform 114 is governed by instructions stored in switch host computer 128. In this illustrative embodiment, switching matrix platform 114 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on system 100 and switching matrix platform 114 for each corresponding function.

Operators may utilize database server 126 to provide information assistance by searching one or more databases through server 126 for telephone numbers of a desired parties, restaurant recommendations, movie listings, events, etc. It should be pointed out that the term “operator” here broadly encompasses entities that are capable of providing assistance in a telecommunication environment, including without limitation human operators, voice response/recognition capabilities, web-enabled operator services, and other electronic access.

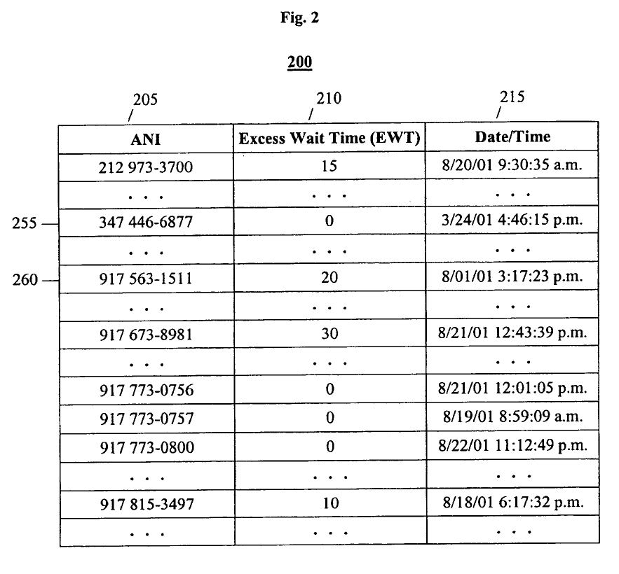

An incoming information assistance call from a caller is received by switching matrix platform 114 in system 100 which connects it to an available operator's telephone. If no operator is available when a call is received, the call is queued in accordance with the invention. In this illustrative embodiment, host computer 128 maintains (e.g., in memory 180) an EWT database 200 illustrated in FIG. 2. In this embodiment, EWP database 200 contains multiple records, one for each phone number associated with a user of the information assistance service. Each record of EWP database 200 includes EWT field 210, registering the EWT of the last information assistance call originating from a communications device having the telephone number in ANI field 205. In a well known manner, platform 114 derives, from the call set-up signals associated with an incoming information assistance call, the automatic number identification (ANI) indicating the telephone number of the communications device from which the call originates.

For example, record 260 indicates that the user associated with the “917-563-1511” phone number (in ANI field 205) has 20 seconds of EWT (in EWT field 210). That is, in the last information assistance call from “917-563-1511,” the user experienced a service wait time of 40 seconds, 20 seconds over the acceptable wait time, which is predetermined to be 20 seconds in this instance. If the value in EWT field 210 is zero, e.g., as in record 255, this could mean that no previous information assistance calls were made from the corresponding phone number in ANI field 205. (When EWT database 200 is created EWT field 210 for all the records is initialized to zero.) Alternatively, it means that the previous information assistance call was answered within the predetermined, acceptable wait time and hence did not incur any EWT.

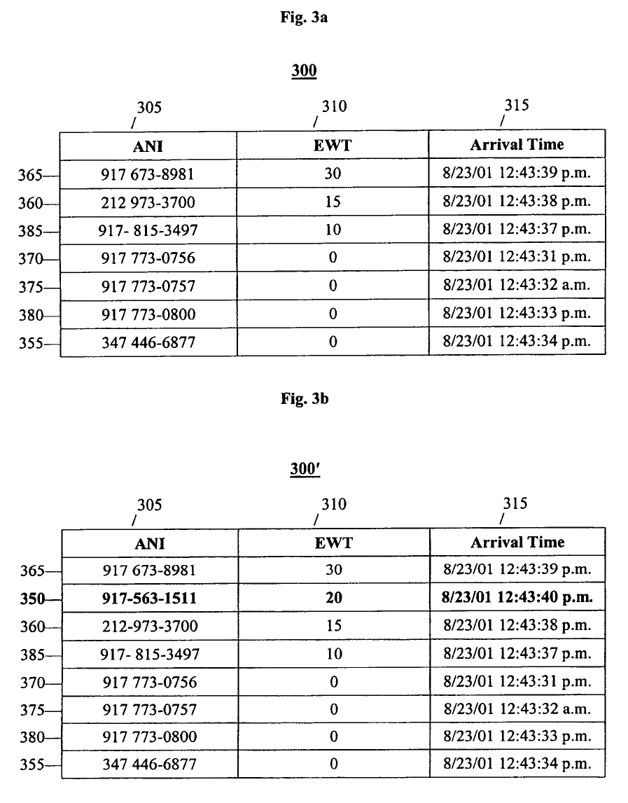

By way of example, FIG. 3a illustrates call queue 300 at the time when a current information assistance call arrived at system 100. Let's say the call was made from “917-563-1511” on Aug. 23, 2001 and arrived at system 100 at 12:43:40 p.m. Queue 300 illustrates the order in which each earlier arrived is to be answered at that time. Illustratively, each earlier arrived call is represented by the telephone number (in ANI field 305) of the communications device from which the call originates, the EWT of the last call (in EWT field 310) associated with the telephone number (or the user), and the arrival time of the call (in Arrival Time field 315).

As shown in FIG. 3a, queue 300 in this instance contains seven calls waiting to be answered. It should be noted that the calls in queue 300 are not ordered according to their arrival times as in the prior art FIFO manner. Rather, in accordance with the invention, they are ordered as a function of the EWTs associated therewith. For example, information assistance call 370 made from “917-773-0756” on Aug. 23, 2001 arrived at information assistance system 100 at 12:43:31 p.m —the earliest call in queue 300. Because of its associated zero EWT value, call 370 is nevertheless placed fourth in queue 300. On the other hand, call 365, even though arriving 8 seconds later at 12:43:39 p.m., is placed first in queue 300 in accordance with the invention because of its largest EWT (i.e., 30 seconds) of all of the calls in queue 300. Calls 360 and 385 which are placed second and third in queue 300 have second and third largest EWTs, 15 and 10 seconds, respectively. The arrival time of information assistance calls is used in this embodiment as a tie-breaker for the calls with the same EWT. For example, all of the calls having the same EWT, e.g., calls 370, 375, 380 and 355 all having a zero EWT, are ordered at the end of queue 300 according to their arrival times, e.g., according to a FIFO scheme.

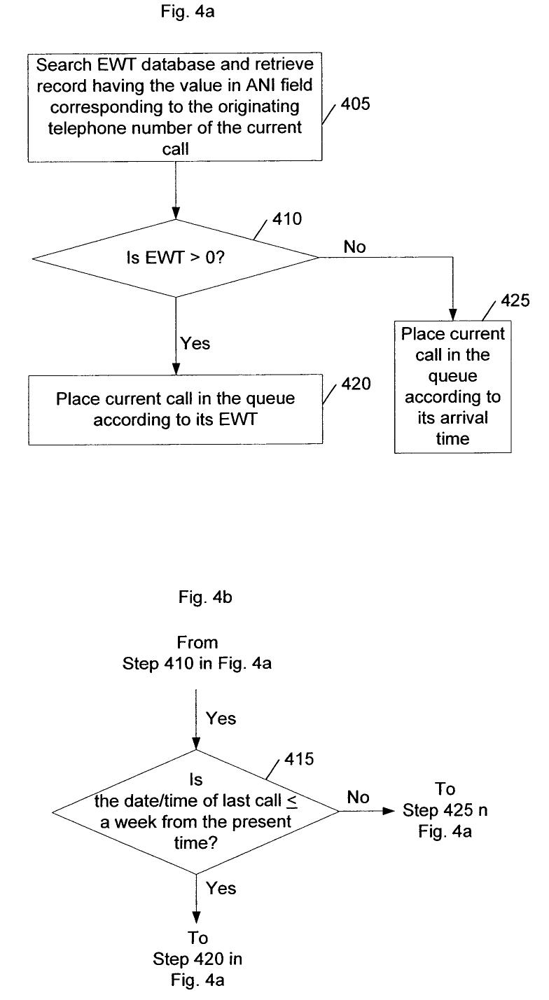

Continuing the above example where the current information assistance call from “917-563-1511” just arrived at system 100, computer 128 determines that the call needs to be placed in a call queue to wait for service. Accordingly, computer 128 executes a call queuing routine depicted in FIG. 4a to queue such a call. In step 405, host computer 128 searches EWT database 200 for a record having the value in ANI field 205 corresponding to the originating telephone number of the current call, i.e., “917-563-1511,” and retrieves the same, which is record 260 in this instance. In step 410, host computer 128 determines whether the value in EWT field 210 of record 260 (i.e., 20 seconds) is greater than zero, which is the case here (20>0). The routine then proceeds to step 420. In step 420, host computer 128 places the current call in queue 300 according to its EWT of 20, resulting in queue 300′ illustrated in FIG. 3b, where the current call is denoted 350.

As shown in FIG. 3b, host computer 128 has placed call 350 second in queue 300′, immediately behind call 365 (having EWT of 30) but before call 360 (having EWT of 15). Thus, in contrast to the prior art FIFO scheme, call 350 just arrived is accorded priority and placed in the call queue ahead of earlier calls, e.g., calls 360, 385, 370, 375, 380 and 355. Thus, by using the inventive call queuing routine of FIG. 4a, the likelihood that call 350 would be answered this time within the acceptable wait time is increased as it is placed second in queue 300′, as opposed to last in the prior art. As a result, a user who experienced a non-zero EWT in his/her prior call is likely to be satisfied with the expeditiousness of the information assistance service answering the current call.

Returning to step 410, if host computer 128 there determines that the EWT value associated with the current call is not greater than zero (e.g., zero), the routine proceeds to step 425, instead, where computer 128 places the current call in the call queue according to its arrival time, i.e., last in the queue.

Thus, if in fact call 350 is answered within the acceptable wait time, after the caller completes the call, host computer 128 updates record 260 in EWT database 200 to change the previous EWT value of 20 seconds in field 210 to zero. In that case, host computer 128 will not accord priority to the subsequent call from the same telephone number (presumably by the same caller) as call 350 due to the zero EWT value associated with the subsequent call. As a result, the subsequent call will be placed last in the call queue, if any, when it arrives at system 100.

However, it will be appreciated that database 200 may not be updated each time a call is completed. It may be updated from time to time, e.g., once a day, once a week, etc.

In accordance with an aspect of the invention, the time elapsed from the information assistance call in which a user experienced a EWT may be a factor in according priority to the user's subsequent call. Thus, in a second embodiment of the invention, a current information assistance call is queued based not only on the value of EWT of the last call from the same user (or the same telephone number), but also on how “recent” the last call is. If the last call in which the user experienced a EWT was made more than a predetermined period ago, e.g., a week ago, it may be safe to assume that the user is an infrequent user of the service and most likely would have forgotten the prior “bad” call experience. As such, no priority is accorded to the current call.

To implement the second embodiment, each record in EWT database 200 also contains date/time field 215 which registers the date and time when the last information assistance call from a user arrived at system 100. For example, record 260 indicates that the last call from “917-563-1511” (in ANI field 205) arrived at system 100 on Aug. 1, 2001 at 3:17:23 p.m. (in date/time field 215), and incurred 20 seconds of EWT (in EWT field 210). In the above example where the current call made by the same user at “917-563-1511” on Aug. 23, 2001 arrived at system 100 at 12:43:40 p.m., the call needs to be placed in queue 300, previously described. In this second embodiment, host computer 128 executes a second call queuing routine similar to that of FIG. 4a previously described, except that after executing step 410 in FIG. 4a and determining that the call satisfies the condition in step 410, computer 128 needs to further execute step 415 in FIG. 4b. In step 415, host computer 128 determines whether the date/time of the user's last call, i.e., Aug. 1, 2001/3:17:23 p.m., is less than or equal to a week from the present time, i.e., Aug. 23, 2001/12:43:40 p.m. Since in this instance the last call is more than a week ago, host computer 128 places the current call last in the call queue according to its arrival time, as indicated in step 425 previously described. Otherwise, if in step 415 host computer 128 determines that the date/time of the user's last call is not more than a week ago, computer 128 places the current call in the call queue according to its associated EWT, as indicated in step 420 previously described.

In accordance with another aspect of the invention, the EWT database may be used to keep track of all calls (or at least those calls incurring a non-zero EWT) on a cycle basis, e.g., a weekly cycle, a month cycle, etc. For example, for each user, the EWT values of all of the calls from the user during the current cycle are cumulated in the EWT database. The cumulative EWT value (as opposed to only the EWT value of the last call in the previous embodiments) may be used to determine priority of the user's current call.

In accordance with still another aspect of the invention, the cumulative EWT value associated with a user is averaged over the number of calls from the user in the current cycle which incur a non-zero EWT. The resulting, average EWT value may then be used to determine priority of the user's current call.

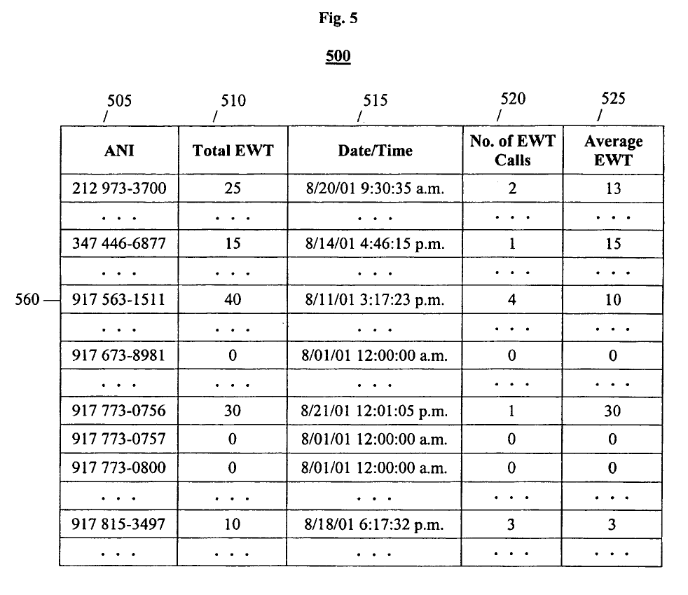

To implement the last two aspects of the invention, EWT database 500 in FIG. 5 may be used. Each record in EWT database 500 contains an originating phone number associated with a user in ANI field 505, a running total EWT incurred in all calls from the user in the current month in field 510, date/time of the user's last call in date/time field 515, and number of the user's calls incurring a non-zero EWT in the current month in field 520. Based on the values in fields 510 and 520, a running average of the EWT per call experienced by the user can be determined (by dividing the value in field 510 by the value in field 520). The resulting average EWT per call is registered in field 525.

For example, at the end of Aug. 21, 2001 EWT database 500 contains record 560, which indicates that the user of “917-563-1511” phone number (in ANI field 505) has experienced a total of 40 seconds of EWT (in Total EWT field 510) in 4 calls during the month of August 2001 (in Number of EWT Calls field 520) with the last call placed on Aug. 11, 2001 at 3:17:23 p.m. (in Date/Time field 515). In this instance, Average EWT field 525 of record 560 registers 10 (seconds) as the running average EWT per call.

In this instance, at the beginning of each month, e.g., at 12:00 a.m. on Aug. 1, 2001, host computer 128 resets all of the fields 510, 520 and 525 in database 500 to zero. After each EWT call originating from a telephone number, host computer 128 updates the corresponding record in EWT database 500 containing the same telephone number in field 505.

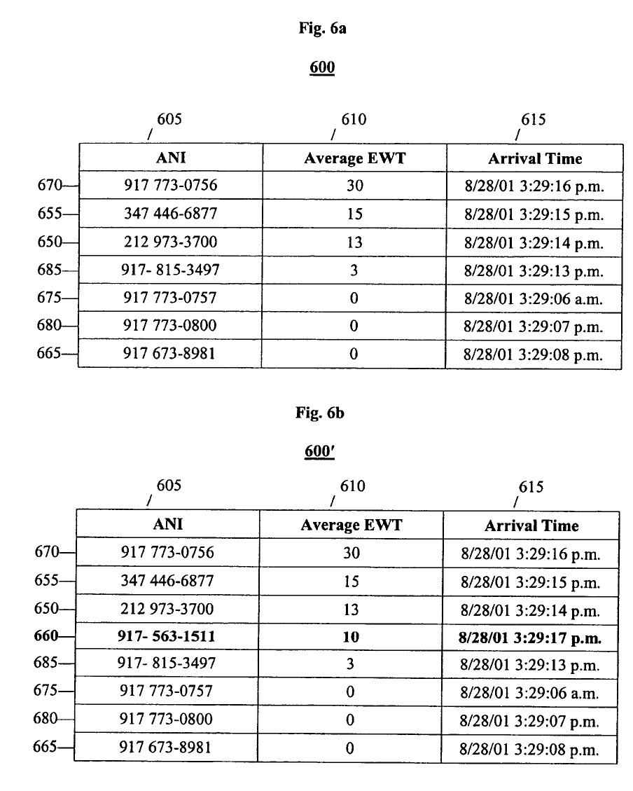

By way of example, FIG. 6a illustrates wait queue 600 at the time when a current information assistance call arrived at system 100. Let's say the call in question was made from “917-563-1511” on Aug. 28, 2001 and arrived at system 100 at 3:29:17 p.m. Queue 600 illustrates the order in which each earlier arrived call is to be answered at that time. Illustratively, each earlier arrived call is represented by the telephone number (in ANI field 605) of the communications device from which the call originates, the average EWT per call (in Average EWT field 610) associated with the telephone number (or the user), and the arrival time of the call (in Arrival Time field 615).

As shown in FIG. 6a, queue 600 in this instance contains seven calls waiting to be answered. It should be noted that the calls in queue 600 also are not ordered according to their arrival times as in the prior art FIFO manner. Rather, in accordance with one of the aforementioned aspects of invention, they are ordered as a function of the average EWTs associated therewith. For example, information assistance call 670 made from “917-773-0756” on Aug. 28, 2001 arrived at system 100 at 3:29:16 p.m —the latest call in queue 600. Because of its associated high average EWT value (e.g., 30 seconds), call 670 is nevertheless placed first in queue 600. On the other hand, call 665, even though arriving 8 seconds earlier at 3:29:08 p.m., is placed last in queue 600 in part because of its zero average EWT value. Calls 655 and 650 which are placed second and third in queue 600 have second and third highest average EWTs, 15 and 13 seconds, respectively. Again, in this embodiment, the arrival time of information assistance calls is used as a tie-breaker for the calls with the same average EWT. For example, all of the calls having the same average EWT, e.g., calls 665, 675 and 680 all having a zero average EWT, are ordered at the end of queue 600 according to their arrival times, e.g., according to a FIFO scheme.

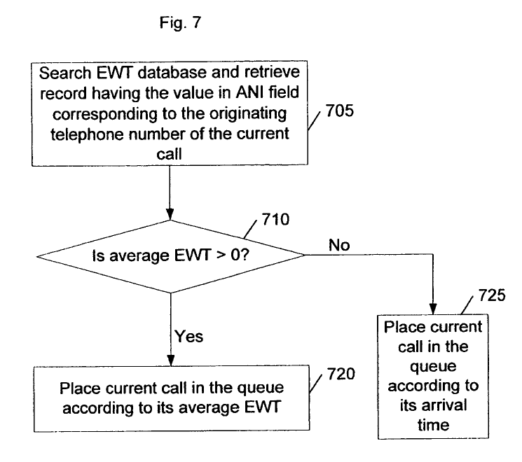

Continuing the above example where the current information assistance call from “917-563-1511”just arrived at system 100, computer 128 determines that the call needs to be placed in a call queue to wait for service. Accordingly, computer 128 executes a call queuing routine depicted in FIG. 7 to queue such a call. In step 705, host computer 128 searches EWT database 500 for a record having the value in ANI field 505 corresponding to the originating telephone number of the current call, i.e., “917-563-1511,” and retrieves the same, which is record 560 in this instance. In step 710, host computer 128 determines whether the value in Average EWT field 525 of record 260 (i.e., 10 seconds) is greater than zero, which is the case here (10>0). The routine then proceeds to step 720. In step 720, host computer 128 places the current call in queue 600 according to its average EWT of 10, resulting in queue 600′ illustrated in FIG. 6b, where the current call is denoted 660.

As shown in FIG. 6b, host computer 128 has placed call 660 fourth in queue 600′, immediately behind call 650 (having an average EWT of 13) but before call 685 (having an average EWT of 3). Thus, in contrast to the prior art FIFO scheme, call 650 just arrived is accorded priority and placed in the call queue ahead of earlier calls, e.g., calls 665, 675, 680 and 685. Thus, by using the inventive call queuing routine of FIG. 7, the likelihood that call 650 would be answered this time within the acceptable wait time is increased as it is placed fourth in queue 600′, as opposed to last in the prior art. As a result, a user who experienced a non-zero EWT in his/her prior calls is likely to be satisfied with the expeditiousness of the information assistance service answering the current call.

Returning to step 710, if host computer 128 there determines that the average EWT value associated with the current call is not greater than zero (e.g., zero), the routine proceeds to step 725, instead, where computer 128 places the current call in the call queue according to its arrival time, i.e., last in the queue.

In an unfortunate event that the current call 650 incurs a non-zero EWT, say, 15 seconds. After completion of call 650, host computer 128 updates record 560 in EWT database 500 by adding 15 seconds to the value in Total EWT field 510 (i.e., 40 seconds), incrementing the value in No. of EWT Calls field 520 (i.e., 4) by one, and changing the value in Average EWT field 525 to the new running average EWT per call, which is 11 seconds in this instance (i.e., 55 seconds divided by 5 EWT calls).

The foregoing merely illustrates the principles of the invention. It will thus be appreciated that those skilled in the art will be able to devise numerous other arrangements which embody the principles of the invention and are thus within its spirit and scope.

For example, it will be appreciated by those skilled in the art that the EWT database may be modified to include only those records having ANIs associated with the users who experienced EWTs, thereby reducing the size of the EWT database. In addition, if host computer 128 cannot locate a record for a particular ANI in the modified EWP database, it would mean that this particular user has not experienced EWT, i.e., EWT=0, and his call would be queued according to its arrival time. After each EWT call, host computer 128 may update the modified EWT database by adding a new record corresponding to a new ANI or by changing EWT in an existing record. For example, it will also be appreciated by those skilled in the art that in an embodiment where a call is queued based on the cumulative EMT value associated with the call, every call incurring a zero EWT results in a reduction of the cumulative EWT value, thus according less priority to a subsequent call from the same user who had one or more “good” call experiences.

It will also be appreciated by those skilled in the art that in another embodiment of the invention, if a user experienced a EWT exceeding a certain threshold, e.g., 100 seconds (whether in a single or multiple EWT calls), a user may be afforded priority in more than one subsequent calls to compensate for such a significant EWT. Each zero EWT call may or may not result in reduction of the EWT.

In addition, in the disclosed embodiment, a monthly cycle is illustratively used where an average EWT per call is determined. It will be appreciated that such a cycle may be of any other length, and the start of the cycle may not be calendar based, e.g., a particular day of each month. Instead, the start of the cycle may vary from user to user, which may be triggered by a user's first call incurring a non-zero EWT.

Finally, information assistance system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method for use in an information assistance system, comprising:
receiving a current call from a user, and signals containing an identifier associated with the user;
determining whether the current call should be placed in a queue to wait for a service provider to render an information assistance service;
if the current call should be placed in a queue, searching a data source for data associated with the user based on the identifier, the data concerning at least one wait period before an information assistance service was rendered in at least one prior call to the system, the at least one prior call being identifiable by the identifier; and
placing the current call in a queue based on the data.

2. The method of claim 1 wherein a position in the queue in which the current call is placed is a function of a difference between the at least one wait period and a predetermined time.

3. The method of claim 2 wherein the predetermined time is zero.

4. The method of claim 1 wherein the at least one wait period includes a plurality of wait periods, and the at least one prior call includes a plurality of prior calls, a position in the queue in which the current call is placed is a function of a sum of the wait periods.

5. The method of claim 1 wherein the at least one wait period includes a plurality of wait periods, and the at least one prior call includes a plurality of prior calls, a position in the queue in which the current call is placed is a function of an average of the wait periods over the number of prior calls.

6. The method of claim 1 wherein the at least one prior call occurred in a predetermined period.

7. The method of claim 1 wherein the service provider includes an operator.

8. The method of claim 1 wherein the identifier includes an automatic number identification (ANI) contained in the signals.

9. The method of claim 1 wherein if the current call does not incur a wait period in excess of a predetermined time, the data is revised to reflect a reduction of a length of the at least one wait period.

10. The method of claim 9 wherein the predetermined time is zero.

11. The method of claim 1 wherein in placing the current call in the queue, the at least one wait period is compared with a second wait period associated with a second call in the queue.

12. The method of claim 1 wherein the information assistance service includes searching a second data source for a telephone number of a desired party.

13. An information assistance system, comprising:
an interface for receiving a current call from a user, and signals containing an identifier associated with the user;
a processor for determining whether the current call should be placed in a queue to wait for a service provider to render an information assistance service;
a data source, if the current call should be placed in a queue, the data source being searched for data associated with the user based on the identifier, the data concerning at least one wait period before an information assistance service was rendered in at least one prior call to the system, the at least one prior call being identifiable by the identifier; and
a mechanism for placing the current call in a queue based on the data.

14. The system of claim 13 wherein a position in the queue in which the current call is placed is a function of a difference between the at least one wait period and a predetermined time.

15. The system of claim 14 wherein the predetermined time is zero.

16. The system of claim 13 wherein the at least one wait period includes a plurality of wait periods, and the at least one prior call includes a plurality of prior calls, a position in the queue in which the current call is placed is a function of a sum of the wait periods.

17. The system of claim 13 wherein the at least one wait period includes a plurality of wait periods, and the at least one prior call includes a plurality of prior calls, a position in the queue in which the current call is placed is a function of an average of the wait periods over the number of prior calls.

18. The system of claim 13 wherein the at least one prior call occurred in a predetermined period.

19. The system of claim 13 wherein the service provider includes an operator.

20. The system of claim 13 wherein the identifier includes an ANI contained in the signals.

21. The system of claim 13 wherein if the current call does not incur a wait period in excess of a predetermined time, the data is revised to reflect a reduction of a length of the at least one wait period.

22. The system of claim 21 wherein the predetermined time is zero.

23. The system of claim 13 wherein in placing the current call in the queue, the at least one wait period is compared with a second wait period associated with a second call in the queue.

24. The system of claim 13 wherein the information assistance service includes searching a second data source for a telephone number of a desired party.
